(19) United States
(12) Patent Application Publication
(10) Pub. No.: US 2025/0282690 A1
(43) Pub. Date: Sep. 11, 2025

(54) NANO-CHELATED COMPLEXES

(71) Applicants: Behrouz Mohammad Einolllahi, Tehran (IR); Mohsen Behrouz Einolllahi, Tehran (IR); Omar El-Farouk Osman, La Cortinada (AD)

(72) Inventor: Behrouz Mohammad Einolllahi, Tehran (IR)

(21) Appl. No.: 18/694,699

(22) PCT Filed: Sep. 22, 2022
(86) PCT No.: PCT/EP2022/076413

§ 371 Date: Mar. 22, 2024

(30) Foreign Application Priority Data
Sep. 23, 2021 (LU) LU500680

(51) Int. Cl. C05B 15/00; C05C 9/00; C05F 11/00; C05G 5/10

(52) U.S. Cl. CPC C05B 15/00; C05C 9/00; C05F 11/00; C05G 5/10

(57) ABSTRACT

Nano-particles of chelated complex compounds useful as chelate fertilizers, each said compound comprising: a chelate complex core made of at least one polycarboxylic acid incorporating therein at least one first cationic compound originating from at least one first source material selected from the group consisting of nitrogen (N), phosphorus (P), potassium (K), magnesium (Mg), calcium (Ca), and zinc (Zn) based compounds, or mixtures thereof, said chelate complex core further comprising at least a second cationic compound originating from at least one second source material selected from the group consisting of nitrogen (N), phosphorus (P), potassium (K), magnesium (Mg), calcium (Ca), silicon (Si),), iron (Fe), zinc (Zn), manganese (Mn), copper (Cu), boron (B), molybdenum (Mo), selenium (Se), cobalt (Co), sodium (Na), nickel (Ni), iodine (I), strontium (Sr), chromium (Cr) and organic carbon (OC) based compounds, or mixtures thereof, forming nano-chelated complex compounds. A process for preparing said nano-chelated complex compounds.

The invention relates to the field of nano-chelated complexes useful as chelate fertilizer in various agriculture fields.

In respect to importance of soil fertilization as a global food security key or sustainable agriculture and also the role of micronutrients and macro element usage; a maximum productivity in terms of quantity and quality of agricultural products needs to be achieved on the one hand and on the other, barriers such as deficiencies of available elements in soils, their calcareous conditions, high pH and water salinity and lack of elements balance in soil and excessive chemical fertilizer usage that cause soil degradation and elements disturbance.

Existing fertilizer, with high consumption and low deficiency, do not have an efficient effect on elements absorption, to nutrients balance and remove nutritional needs. Modern agriculture requires that many products be used (in combination) in order to cover these deficiencies, often leading to high costs

Excessive usage of chemical fertilizer has disturbed soil and subsoil waters, creating various diseases and carcinogens in growing societies reflects the need of designing products that have no negative effects

Elevated use of urea and phosphate fertilizers in agricultural practices converts to nitrate and cadmium, where it accumulates within the produces. Nitrates and other converted heavy metals are considered as carcinogenic substances that causes gastrointestinal cancer, neurological abnormalities and disorder in endocrine system and immune system. In addition to carcinogenicity, it causes stunting and disorder in renal function.

Based on Liebig's law of the minimum, nutrients usage should be fit to plant's need and all elements should be available according to the requirements of the plant's growth stage. The balance between elements is very important and needs to be reflected with a proper balance of different concentration of elements in the soil and plant absorption pathways (root base structure and leaf surface).

In recent years, a high consumption fertilizer usage has been in combination with ethylenediaminetetraacetic acid (hereinafter “EDTA”) chelating agents. This new technology provides the ability to apply fertilizers in a more efficient manner and in different types of application (i.e. foliar sprays). Most of the available chelated fertilizers are mono element or a combination of elements that are used as fertilizers, with relatively low percentage in terms of concentrations. According to research performed, in both land and hydroponic environments, while the concentration of minerals chelated with EDTA increased, it was noticed that plant uptake did not follow due to the high molecular weight of the EDTA ligand. The molecular weight and negative charges profile of EDTA-chelated minerals, the adsorption of the elements requires increased energy and reduces the performance within the plant absorption in transporting the chelated minerals through the cellular walls, which reduces their root structure and shoot length.

Chelate compounds, i.e., chelating agents, chelate complexes, chelants, chelators, and/or sequestering agents, have numerous commercial applications, such as, for example, plant nutrition as fertilizers, and animal nutrition and treatment as supplements and medicines, respectively. Known chelating agents include EDTA and ethylenediamine-N,N′-bis(2-hydroxyphenylacetic acid) (hereinafter “EDDHA”), and known chelate complexes include iron-EDTA (hereinafter “Fe-EDTA”) and iron-EDDHA (hereinafter “Fe-EDDHA”).

Fertilizers that contain Iron (Fe) elements are also of interest and made by different bases such EDDHHA-HEDTA-EDDHA-OTPA-EDTA in recent years. EDDHA also does not deliver high percentage of Iron or other elements, such as Felixper 6% EDDHA (Germany) and Omex Iron chelated (England) and Grow More 6546 EDDHA Iron Chelate and others. These fertilizers are expensive and technology base on (Ortho-Ortho) or (Ortho-Para) or (Para-Para) Isomers that are stable, semi stable and unstable, were used respectively.

In recent year, there has been a focus on Iron chelated fertilizers within the market. It should also highlight the need for equilibrium of multiple elements in plants to promote optimal and healthy plant growth.

The rhizosphere is a microecological area in the immediate vicinity of the plant root, where rapid and numerous chemical interactions occur. Its environment is more competitive than the soil mass. Compounds added to the soil by the roots are classified into four categories: exudates (passively removed from the roots), secretions (actively removed from the roots), dead cells, and gaseous compounds. The chemical and biological processes that take place in the rhizosphere not only determine the mobility and uptake of soil nutrients, but also control the efficiency of nutrient consumption. Establishing an integrated nutrient management strategy in the root zone is an effective way to solve the problem; along with high product yields, nutrient efficiency and environmental protection. It is estimated that decreasing each unit of acidity potentially increases the absorption 100 times.

The pH regulation is one of the most important factors for optimizing mineral availability for plants. Acidic soils are defined as having a pH under 4.5. At this pH level, elements such as iron, aluminium and manganese become significantly soluble and can lead to toxicity in plants. When soil pH reaches 5.5, nitrogen will be most available for plants. When soils reach levels between 6 and 7, phosphorous is at its optimal availability for plants.

WO 2017/168446 A1 concerns metal oxide based soil conditioners comprising nano iron oxalate capped metal oxide(s) (Fe, Mn, Cu) that are capable of enhancing the iron availability to plants from soil without increasing soil acidity and hindering phosphorous availability in soil in comparison to conventional iron fertilizers. Said iron oxalate capped metaloxides also enhance the nitrogen and phosphorus availability in such treated soil. Moreover iron oxalate capped metal oxide nanomaterials comprising Fe sourced from iron salt other than Mohr salt show at least four folds enhanced Fe release capability in soil with respect to the nanomaterials with Fe sourced from Mohr salt. Metal oxide based soil conditioner is a reaction product of iron salts other than Mohr's salt, and oxalic acid followed by reduction with sodium borohydride, and optionally other metal salts at elevated temperature.

There are no current chelate combination available for enhancing plant absorption and improved efficiency. Besides, there is always a need to improve chelated fertilizer in agriculture in terms a broad pH stability when used in situ, lowered potential for soil toxicity, increased absorption ability of a mineral by the plant, using a process of manufacture thereof without any need of heat, adjuvants, additives, i.e. silicon dioxide, titanium dioxide, catalysts, solvents, surfactants, dispersant and/or preservatives, among others.

For solving at least one of the above needs and/or drawbacks, the invention provides nano-particles of chelated complex compounds, useful as chelate fertilizers, each said compound comprising:
a chelate complex core made of a at least one polycarboxylic acid and incorporating therein
   at least one first cationic compound originating from at least one first cationic source material of nitrogen (N), phosphorus (P), potassium (K), magnesium (Mg), calcium (Ca) or zinc (Zn), or mixtures thereof,
   said chelate complex core further comprising
   at least one second cationic compound originating from at least one second cationic source material of nitrogen (N), phosphorus (P), potassium (K), magnesium (Mg), calcium (Ca), silicon (Si), iron (Fe), zinc (Zn), manganese (Mn), copper (Cu), boron (B), molybdenum (Mo), selenium (Se), cobalt (Co), sodium (Na), nickel (Ni), iodine (I), strontium (Sr), chromium (Cr) and organic carbon (OC), or mixtures thereof, forming nano-chelated complexes compounds,
   wherein the particle size thereof is ≤100 nm.

Such nano-particles of chelated complex compounds, presenting a particle shape, exhibit reduced surface tension force and increase contact surface of leaves and/or root structure of a plant, accelerated cell membrane crossing and plant vascularization, increased absorption ability, decreased consumption during plant growth, lowered potential for soil toxicity due to non-fixation in soil and higher economic efficiencies. In other words, said compounds optimize plant absorption of various elements that are in soil and provide proper balance in order to promote optimal growth, yield, as well as eliminating deficiencies in plants.

Moreover, such nano-chelated complexes present stable profile in soil/agriculture environment within a pH range of 3 to 8.5. This stability profile is especially important as agriculture soils vary widely from region to region and country to country. Said compounds are stable but bio-available to plants. The manufactured final nano-particles of chelated complex compounds are water soluble and have a pH ranging from 0.5 to 4.0, depending on the product composition.

One of the main aspects of the invention, is that the particles size of said nano-chelated complexes is not higher than 100 nm, especially of from 10 nm to 100 nm, and that the nano-chelated complexes can support high concentration of elements. Such particle size of the nano-chelated compounds reduces surface tension and increase contact surface (surface area) of plant surfaces, such as root, leaf, stem and fruit, with fertilizer particles, as well as increases the efficiency to penetrate cell walls and nutrient absorption.

In the context of the invention, “nano-particles of chelated complex compounds”, otherwise named “nano-chelated complexes or compounds” or “nanoparticle(s)” are generic complexes between the at least one polycarboxylic acid and the first cationic compound, otherwise named “core macroelement”, and the second cationic compound, either named “microelements” or “macroelements” depending on the ionic element added, are created, for example named “nano-chelated complexes”.

In the context of the invention, the first cationic compound(s) can be supplied or are originating from cationic source materials, otherwise named source materials, providing the cationic form of, for example, N, such as urea, ammonium nitrate for N, and zinc oxide, zinc sulphide, zinc nitrate, phosphoric anhydride (P₂O₅), triple superphosphate (TSP), di-ammonium phosphate ((NH₄)₂HPO₄), mono-ammonium phosphate (MAP), potassium oxide (K₂O), potassium sulphide (K₂S), potassium nitrate (KNO₃), magnesium oxide (MgO), magnesium sulphide (MgS), magnesium nitrate (Mg(NO₃)₂), calcium oxide (CaO), calcium sulphide (CaS) and calcium nitrate (Ca(NO₃)₂), or mixture thereof.

The same applies for the definition of the second cationic compound(s) that can be supplied or originating from cationic source materials providing the cationic form(s) thereof. For the elements other that N, K, P, Mg and Ca, in their cationic form, as second cationic compound(s), the counter ions may be, and non are limited to, sulphide, nitrate, oxide, sulphate.

The final nano-particles of chelated complex compounds may contain especially free ions of the incorporated elements (first cationic and second cationic compounds), ions H⁺/OH, functional groups and organic carbon COOH. The created complex can be summarized as high purity elements chelated with a single or combination of polycarboxylic acids.

The nano-chelated complexes improve the delivery and collection of various ionic elements and/or metal ions in all pH environments, including highly acidic and alkaline environments. The unique arrangement of the atoms and molecules due to self-assembly of the nano-chelated complexes results in the formation of a structure exhibiting higher resistance against structural breakage and/or deformation in highly acidic or alkaline environments.

The customizability options of the nano-particles to deliver or collect different elements and/or metal ions enables the nano-chelated complexes to be optimized for various uses. The nano-chelated complexes can have a tailor-made approach to farming if required, based on the soil characteristics and the desired crop.

The nano-chelated complexes produced are environmentally friendly and can be used for all types of agriculture; Crops (farms and greenhouses), Horticulture, Orchards, Plants, Flowers and/or Forestry.

While a single or multiple source elements can be received within the polycarboxylic acid complexes, combination up to 17 source elements, i.e. first and second cationic compounds, within the polycarboxylic acid in a stable fashion, could be done to obtain a stable structure of nano-chelated complexes. In some embodiments, the common use will dictate the necessity to be between 1 to 14 ionic elements for agricultural purpose. Consequently, a mixture of various individual nano-particles is obtained. In said mixture, each individual nano-chelated complex may include at least one of the first cationic compound, such as cationic forms of N, and at least one second cationic compound, such as cationic forms of Zn. In some embodiments, and depending on conditions of the process for obtaining thereof, each individual nano-particle may include 1 or more, preferably of from 1 to 14, of the first cationic compounds, which could be identical or different, and of from 1 to 14 of the second cationic compounds, which could be identical or different, the number of both said cationic compounds being less than 17, more preferable of from 9 to 17, or 10 to 17, even better 11 to 17 or 12 to 17. According to an advantageous embodiment, without being bound by any theory, a nano-chelated complex includes a chelate complex core structure of the polycarboxylic acid and the at least the first cationic compound, wherein the at least one first cationic compound is embedded or encapsulated within the polycarboxylic acid, and further the second cationic compound, wherein the particle size is less than 100 nm. Preferred chelate complex core structure is when the first cationic compound is based of N or P originating from a cationic source of N or P, leading to a robust chelate/complex structure that renders the final compound, nano-chelated complexes, stable and efficient in terms of uses in agriculture.

In the context of the invention, the “particle size” of the nano-chelated complexes has to be understood as the largest measured mean diameter of the whole/various particles forming the nano-chelated complexes, said particles, as a whole, that may have various shapes including, for example, spherical and/or ovaloid shapes, or even rod like shape.

Without being bound by any theory and, in some instances, the mean diameter of each particle is less than 100 nm. For example, if the particle is ovaloid, then the particle size thereof represents the diameter or a distance between two points at the end of each particle edge. Consequently, each particle has a particle size of less than 100 nm, regardless its shape, but it should be understood that the largest diameter or a distance between two points at the end of each particle edge, as defined above, is less than 100 nm.

Very advantageously, the nano-particles of chelated complex compounds may be spherical and/or ovaloid particle structure(s) with preferentially a non-homogeneous rough surface. The nano-particles of chelated complex compounds having particle size ranging from 10 nm to 100 nm being and being water soluble, may allow for a high surface area contact with the plant surfaces (leaf or roots) and optimal uptake of mineral nutrients.

When the produced nano-chelated complexes are used as fertilizers in agriculture, they have a positive effect on increasing the yield of crops, enhancing the crop nutrient profile, improve the crop robustness for transport and increasing the shelf-life, due to improved retained water profile, and eliminate the risk of fertilizer toxicity, due to the significantly lower quantity of fertilizer needed, for example between 7 to 20 less than traditional fertilizers. The use of the described fertilizer has the ability to increase the resistance of plants against pests, temperature fluctuations and other threats from the environment. In addition to benefits to the crops and agriculture, the use of the nano-chelated complex fertilizers also have great environmental benefits; balancing soil toxicity levels, increases solubility and absorption of microelements in soils, releasing elements fixation (phosphorus, nitrogen ammonium and nitrates forms-, potassium, calcium and magnesium in cationic forms) in soils, increases nitrogen absorption, reduce and rebalance underwater table pollution, increasing or maintain viable soil microorganisms and worm populations, energy producing in rooting and fruiting, reduces plant stress by modulating the rhizosphere pH for optimal absorption of mineral, protect free-ions from leaching into water, protecting sea life from harmful nitrates, presence and/or reduction of heavy metals from soil, use of less water due to higher availability and efficient absorption of minerals, the produced chelated nano complex fertilizers can be used. In some embodiments, two or more types of nano-chelated complexes may be obtained. The first type of chelate compound may be chelate complexes, nanocomplexes, transporters, and/or nanotransporters that can deliver an ionic element and/or metal ion to a target. For example, calcium chelate nanocomplexes can deliver ionic calcium to a target, such as, directly to a plant cell. The second type of chelate compound may be chelating agents, nanoagents, chelators, nanochelators, collectors, and/or nanocollectors that can trap an ionic element and/or metal ion from a target and release it under the right conditions, such as soil pH, humidity, and temperature.

According to an advantageous embodiment, the polycarboxylic acid may be at least one acid selected from the group consisting of succinic acid (C₄H₆O₄), oxalic acid (C₂H₂O₄), malic acid (C₄H₆O₅), tartaric acid (C₄H₆O₆), citric acid (C₆H₈O₇), lactic acid (C₃H₆O₃), butanetetracarboxylic acid (C₈H₁₀O₈), and itaconic acid (C₅H₆O₄) (C₆H₁₂O₇), or mixtures thereof.

According to the invention, EDTA, EDDHHA, HEDTA, EDDHA, OTPA and the like are very preferentially excluded.

Preferably, the polycarboxylic acid may be at least one acid selected from the group consisting of malic acid (C₄H₆O₅), lactic acid (C₃H₆O₃), butanetetracarboxylic acid (C₈H₁₀O₈) and itaconic acid (C₅H₆O₄).

In the invention, the polycarboxylic acids are used for preparing the chelate complex core. In some examples, the unique blend of several polycarboxylic acid produces an environmentally friendly fertilizer with properties to increase the soil microorganism population, protect and/or stimulate earthworm populations, accumulate nutrient elements, reduce surface tension, improve mineral absorption profile; fast and increase mineral availability (root, leaf, stem and fruit) and accelerate the expansion of the elements in spraying and free-ions protection.

Preferably, the chelate complex core is consisting only of said at least one polycarboxylic acid, i.e. excluding all other organic acids, especially mono-carboxylic acids or other chelating agents known in the art, such as sulfur, seaweed, animal manure. With the sole use of at least one polycarboxylic acid, the assembled nano-chelated complexes have a higher order than their isolated components. The weak acid environment generated by the polycarboxylic acid(s), in combination with the nano particle size, provides for a robust and flexible structure that allows for interaction with the host plant and ensures a targeted delivery.

Advantageously, the relative weight percent of the polycarboxylic acid in each nano-particle may be within the range of from 15 to 40 wt %, more preferably of from 20 wt % to 35 wt %, providing the advantages above exposed.

Preferably, the particle size of the chelated complex compounds is of from 10 nm to 100 nm, more preferably of from 15 nm to 90 nm, even of from 20 to 80 nm, especially of from 30 to 80 nm. In some alternate embodiments, the particle size may be below 150 nm, in particular between 10 nm to 150 nm.

Advantageously, the nano-chelated complexes of the invention, useful as chelate fertilizers, is solely consisting of a chelate complex core made of said polycarboxylic acid, or mixtures of polycarboxylic acids, incorporating therein said at least one first cationic compound, and further said at least a second cationic compound. The nano-chelated complexes can use the same cationic compound for both purposes for mono-element fertilizers (i.e. Nitrogen, Potassium, Zinc ions). The Applicant has obtained nano-chelated complexes that advantageously do not include any further compound to increase the stability thereof, i.e. EDTA, EDDHHA, HEDTA, EDDHA, OTPA and the like. Likewise, the nano-chelated complexes do not avantageously include any further compopund selected from the group consisting of multi-walled carbon nanotubes (MWCNTs), hydroxyfullerenes, iron dioxide (FeO₂), silver nanoparticles (AgNPs), silicon dioxide (SiO₂), titanium dioxide (TiO₂), silver oxides, catalysts, dispersants, nano-additives and preservatives, or mixtures thereof, while not impairing the technical effect thereof.

Advantageously, the weight percentage of the first cationic compound in the chelate complex core may be within the range of 5 to 35 wt %, preferably of from 5 to 30 wt %, more preferably of from 5 wt % to 25 wt %, the rest weight % being the polycarboxylic acid, providing a stable complex. The “wt %” means the weight of the first cationic compound based of the total weight of the chelate complex core. In the example of zinc mono-element complex with a target of product concentration of 20% free ions, urea is first granulated with a polycarboxylic acid blend in order to create the first cationic compound mix. This mixture will be considered as the chelate complex core that supports further elements to be built upon. In this first granulation, the wt/wt ratio or urea versus the final zinc nano-chelate complex weight can be considered as 15%. The role of the urea is to deliver 5% of nitrogen in the form of NH₃ ion to support the chelate complex core. As for the polycarboxylic blend used in the formation of the chelate complex core, it may be stated that it represents approximately 25% of the total zinc nano-chelate complex. In all, the core complex can be considered as contributing to 20% wt/wt of the Zinc 20% nano chelate complex final weight.

The weight % of the second cationic compounds, that are set on the chelate complex core, are predetermined by agronomic specialists to in fact release the appropriate quantity of cationic compounds for plants. It appears that said useful released quantity, being the bioavailable (dissolved or free-ion minerals) percentage for use as fertilizer, is less than the wt % of the cationic compounds. For example, “fertilizer mixtures with 25 wt % of phosphorous in cationic form” as used in agriculture, are in fact nano-chelated complexes which are prepared using 65 wt % of phosphorous source material for generating the second cationic compound, but only 25% are bioavailable, independently of the nature of chelate complex core. Another example are “fertilizer mixtures with 10 wt % of iron in cationic form”, which are nano-chelated complexes prepared using 70 wt % of iron source material for generating the second cationic compound, but only 10% are bioavailable independently of the nature of core chelate complex, due to the elevated weight of the source iron carrier. For these both examples, the final nano-chelated complexes may also contain some lower wt % of other second cationic compounds. Another example is an iron mono-element complex with a concentration 12%, according to which 40% of iron oxide and 20% iron sulphate w/w are used, where the remaining 40% would be the polycarboxylic acids blend. In this case, there is 12% of free-ion iron chelated within the polycarboxylic acid complex that is available to the plant, while 60% of iron source material is used within the formulation.

The above mentioned advantages may create nano-chelated complexes of high availability for plants, the net weight percentage of each of the second cationic compound in its soluble form respectively, i.e the bioavailable percentage, based of the total mass of each particle may be: of from 0 to 20% of N, of from 0 to 30 wt % of K, of from 0 to 25 wt % of P, of from 0 to 25 wt % of Mg, Ca and Mn, of 0 to 22 wt % of Zn, of from 0 to 15 wt % of Fe, of from 0 to 15 wt % of Cu, Se, Co, Na, Ni, I, Sr, Cr B, Si, and OC, independently, in cationic form, the total weight % being different from 0. The bioavailability percentage is very preferentially measured by methods used to assess product quality and are selected from the group consisting of ISO/IEC 17025, ASTM D1217, OECD-105, OECD-122, OECD-109, ISO 22036-2008, OECD-120 and ISO 11885/ESB.

For example, for obtaining a nano-fertilizer comprising 20 wt % of cationic zinc, said weight % being the bioavailable percent, 5 wt % of urea (45%) is used as the first source material providing N cation, as the first cationic compound, 25 wt % of any polycarboxylic acid, then 65 wt % of a mixture of zinc-oxide, -sulphide, -nitrate are used.

For obtaining a nano-fertilizer comprising 10 wt % of iron in cationic form, said weight % being the bioavailable percent, 5 wt % of urea (45%) is used as the first source material providing N, as first cationic compound, 25 wt % of any polycarboxylic acid, then 55 wt % of a mixture of iron-oxide,-sulphide,-nitrate are used. This specific fertilizer includes some low amounts of other compounds, such as K, Zn, Ca, Cu, Mg and Mn.

The combination of the number of ionic elements and the bioavailable wt % of each is determined on the purpose for which the final nano-particles are designed. For example, a combination or mixture of nano-chelated compounds can be designed based of zinc (Zn—5%), manganese (Mn—5%) and calcium (Ca—0.4%) cations for the purpose of prevention of falling fruit. Another example would be a combination of nano-particles based on nitrogen (N—3%), phosphorus (P—1%), potassium (K—1.5%), magnesium (Mg—4%), calcium (Ca—0.7%), iron (Fe—2.5%), zinc (Zn—3%), copper (Cu—0.01%), manganese (Mn—0.8%), boron (B—0.06%) cations, for the general enhancement & increase of brix and colour of tomatoes.

The nano-chelated complexes may be available as a powder or in liquid form for use in agriculture. Depending on the final formulation type (powder or liquid) of said nano-chelated complexes, the above-defined bioavailable percentage of second cationic compounds present therein may vary due different environment where the second cationic compounds are.

As an example, nano-particles of chelated complex compounds may comprise 25 wt % of a polycarboxylic acid, 10 wt % of the first cationic compound(s) and 65 wt % of the second cationic compound(s), the latter wt % not being the bioavailable percentage.

The invention also relates to a process for preparing nano-particles of chelated complex compounds of the invention, comprising the followings steps of:
a) adding a predetermined quantity of at least one polycarboxylic acid into a predetermined quantity of at least one first cationic source material providing at least one first cationic compound of nitrogen (N), phosphorus (P), potassium (K), magnesium (Mg), calcium (Ca), and zinc (Zn), or mixtures thereof, and blending the whole, thereby forming chelate complex core compounds made of the at least one polycarboxylic acid incorporating the at least one first cationic compound therein;
b) milling and particle sizing of the chelate complex core compounds obtained in step a);
c) adding a predetermined quantity of at least one second cationic source material providing at least one second cationic compound, of nitrogen (N), phosphorus (P), potassium (K), magnesium (Mg), calcium (Ca), silicon (Si),), iron (Fe), zinc (Zn), manganese (Mn), copper (Cu), boron (B), molybdenum (Mo), selenium (Se), cobalt (Co), sodium (Na), nickel (Ni), iodine (I), strontium (Sr), chromium (Cr) and organic carbon (OC) or mixtures thereof, to the chelate complex core compounds, and of mixing thereof, resulting in a nano-chelated complexes mixture;
d) milling and particle sizing of the mixture obtained in step c) thereby forming nano-particles of chelated complex compounds, wherein particle size thereof is ≤100 nm.

All advantages of the obtained nano-chelated complexes, wherein particle size thereof is ≤100 nm, have been previously commented.

The step a) consists in adding a predetermined quantity of at least one polycarboxylic acid into a predetermined quantity of at least one first source compound providing at least one first cationic compound, said first source compound being selected from the group consisting of nitrogen (N), phosphorus (P), potassium (K), magnesium (Mg), calcium (Ca), and zinc (Zn) based compounds, or mixtures thereof, and blending (or mixing) the whole, thereby forming chelate complex core compounds made of the at least one polycarboxylic acid incorporating the at least one first cationic compound therein.

All the terms used in the process, i.e. first and second cationic source materials, first and second source materials, or even first and second mineral material(s) have the same meaning, and are providing the cationic compounds, and also have the same meaning as those aforedescribed.

Before step a), the process may include, when applies, an initial step of milling each of the raw materials, i.e. the at least one polycarboxylic acid, said first source material(s), and second source material(s), to obtain particles presenting sizes of about 100-300 nm. Preferably, no heat or chemicals, such as aqueous solutions or various organic solvents, are used in this process step. Said step of milling is performed which all classical tools known to the one skilled in the art, such as mechanical milling devices. The raw materials are used as such whatever they are solid powder components or liquid or viscous at ambient temperature.

First source material(s) for providing the first cationic compounds may be, without being limited, urea, ammonium nitrate, zinc oxide, zinc sulphide, zinc nitrate, phosphoric anhydride (P₂O₅), triple superphosphate (TSP), di-ammonium phosphate, mono-ammonium phosphate (MAP), potassium oxide, potassium sulphide, potassium nitrate, magnesium oxide, magnesium sulphide, magnesium nitrate, calcium oxide, calcium sulphide and calcium nitrate, or mixture thereof.

Preferably, after the optional initial step of milling and before the step a), the process may include a step of blending the first source material(s). Said step of blending is performed which all classical tools known to the one skilled in the art.

The polycarboxylic acids may be those mentioned previously.

Preferably, step a) may use only the at least one polycarboxylic acid, i.e. excluding all other organic acids, especially mono-carboxylic acids or other chelating agents known in the art, such as sulphur, seaweed, animal manure. Advantages of the only use of said polycarboxylic acids were described previously.

Owing to step a), the first cationic compound becomes fixed into a chelate structure, thereby forming chelate complex core compounds made of the polycarboxylic acid(s) incorporating first cationic compound(s) therein. Mixture of various said chelate complex core compounds may include said compounds with different acids and different first cationic compounds. This step a) is devoted to prepare said chelate complex core to receive multiple further first cationic compound(s) and second cationic compound(s), respectively also named macronutrients/macro-elements-micronutrients/micro-elements.

In some preferred embodiments, when the chelate complex core compounds of step a) include a N or P cation as the first cationic compound, then step a) is carried out using, as first source material, a nitrogen or phosphorous containing source compound. The chelate complex core compounds including nitrogen or phosphorous cation may improve the robustness of the chelate complex core structures that allows to produce the final nano-chelated complexes even more stable and efficient, compared to those obtained with other first cationic compounds.

The predetermined quantity of the at least one first source material may be selected as to achieve the desired wt % of the first cationic compound. Said quantity is generally predetermined according to some preliminary studies of agronomists for obtaining the appropriate bioavailable cation combination of the final product, which determines the wt % of the first cationic compound in the chelate complex core.

In some embodiments, the predetermined quantities in step a) may be preferentially such that the weight ratio polycarboxylic acid(s): first source material(s) is of from 2:1 to 1:3. This weight ratio advantageously allows to structurally support the chelate complex core and improves the stability of the second cationic compound(s) added thereon (step c)), for obtaining the nano-chelated complex compounds.

Step a) and the optional prior steps, i.e initial step of milling and/or step of blending the starting raw materials (polycarboxylic acid(s) and first source material(s)), may be repeated multiple times. Accordingly, said step a) may be advantageously performed repetitively until the concentrations of macronutrients are achieved and uniformly coated. The first source material(s) may be added in a step by step manner or pre-blended and added as a dry blend prior to step a).

In step a), the blending of the compounds may be carried out using the raw materials, but, upon need, a minimal amount of an aqueous solution, preferably, purified water, may be added. This may be necessary to induce the chelation reaction between the polycarboxylic acid and the first source compound (hydrolyzation of the acid(s) and ion exchange), quantity thereof being as low as possible, for example for obtaining a heavy paste.

Step b) relates to the milling and the particle sizing of said chelate complex core compounds, preferably through wet milling. This step may be repeated until the desired particle size of typically below 150 nm is achieved. Said particle sizes are homogenized using a mechanical milling technology, preferably fluidized bed technology.

Steps b) is followed by step c) of adding a predetermined quantity of at least one second cationic source material providing at least one second cationic compound. The second cationic compound is thus selected from cationic forms of elements selected from the group consisting of nitrogen (N), phosphorus (P), potassium (K), magnesium (Mg), calcium (Ca), silicon (Si), iron (Fe), zinc (Zn), manganese (Mn), copper (Cu), boron (B), molybdenum (Mo), selenium (Se), cobalt (Co), sodium (Na), nickel (Ni), iodine (I), strontium (Sr), chromium (Cr) and organic carbon (OC) based compounds, or mixtures thereof, to the chelate complex core compounds, and of mixing thereof, resulting in a nano-chelated complexes mixture. Up to 17 elements (first and second cationic compounds) may be advantageously combined within each chelate complex core compound(s), while maintaining a stable final nano-chelated complex. Heavy metals such as lead (Pb), cadmium (Cd) and arsenic (As) in cationic form may also be added within the core chelate complex compound, though these are less preferred.

Second source material(s) may be added into the chelate complex core compounds in a step-by-step approach. In this approach, a single second cationic compound is added one at a time and individually, and this is repeated for each second cationic compound until the desired combination and concentration of each second cationic compound is achieved. Second source material(s) may also be pre-blended together and added in a single step. It is more preferable to carry out step c) with cationic metal elements (i.e. iron, zinc) be integrated first in the chelate complex core compound(s), followed by cationic non-metallic (i.e. manganese, boron) elements. This process can be performed cationic element by cationic element or multiple cationic elements can be added at once depending on the desired concentration and synergetic properties of the added elements.

Step c) may also include the presence of the considered polycarboxylic acids added concomitantly with the second source material(s). This allows to fix the added second cationic material(s) into the chelate complex core compound(s). In some embodiments, the weight ratio polycarboxylic acid(s): second source material(s) may be of from 2:1 to 1:5. This improves the stability of the second cationic compound(s) in the chelated complex compounds of the step a).

As for the first source material(s), the second source material(s) that may be used are oxides, sulphides and nitrate of each of used said materials.

In some embodiments, the weight ratio between the chelate complex core(s): second source material(s) may be of from 2:1 to 1:3. This weight ratio advantageously allows to structurally support the chelate complex core and improves the stability of the second cationic compound(s) added thereon (step c)) for obtaining the chelated complex compounds

In some circumstances, the process may include, after step c) and before step d), an addition of water and a mixing step. This may be necessary to induce the chelation reaction between the chelate complex core and the second source material(s) (hydrolyzation of the acid(s) and ion exchange), quantity thereof being as low as possible, for example for obtaining a heavy paste.

Step d) relates to milling and the particle sizing of the mixture obtained in step c), for example through wet milling, allowing to obtain a powder of said final compound which could be wet. This step may be repeated until the desired particle size of ≤100 nm, of final nano-chelated complexes is achieved. Preferably, said step d) is carried out to obtain particle size of preferably 10 nm to 100 nm, more preferably of from 15 nm to 90 nm, even of from 20 to 80 nm, especially of from 30 to 80 nm. A fluidized bed device may be used. In some alternate embodiments, step d) is carried out until the particle size is below 150 nm, in particular between 10 nm to 150 nm.

Advantageously, steps c) and d) may be repeated multiple times until the concentration of the added second cationic compounds are achieved and uniformly coated.

The Applicant has shown that the milling steps at each successive addition of first and second materials and polycarboxylic acids, steps b) and d), is of importance in order to obtain the desired end compounds, especially of spherical and ovaloid nanoparticles, or even tubular. The nano-particles of chelated complex compounds are exhibiting spherical and ovaloid (or tubular) structure, as well as being in the desired nano-particle range (≤100 nm). The latter generates particles with much larger surface area and a particle size that are easier absorbed by the plants and crops. If only one or two milling steps are performed only after step c) (step b) being then omitted), then the final particles, the chelated complex compounds can no longer be considered as nano-particles, are much larger in size, for example 700 nm-3000 nm, and have a square and rectangular shape, hence minimizing the surface area and potential absorption by the crops.

After step d), the process may include, if necessary, a further step e) of drying and final particle sizing of the final nano-chelated complexes. The product is processed until stable nano-chelated complexes are achieved, with particle size being lower than 100 nm. The final powder of nano-particles may then be collected and stored for future packaging operations. The final nano-chelated complexes may undergo further purification step(s) (step f) through filtration, sieving, crystallization and centrifugation with known and classical devices.

After step f), a further step may describe final particle sizing of the powder of chelated complex through additional wet milling. The product may be processed until a stable nano-chelated complex is achieved, with particle size being lower than 100 nm. The final powder is then collected, transferred into mixing vessels and quantum satis (QS) with water for storage at a correct/desired concentration.

Very advantageously, the process may carried out at temperature less than 35° C. A cooling system is then required in order to ensure that temperatures do not exceed 35° C. This assures that the minerals and elements are not denaturized or altered, providing stability of the chelate complex core compounds and the nano-chelated complexes without or with particle size less than 100 nm, thereby preventing any loss of efficiency of minerals upon agriculture use, all along the implementation of various steps of the process.

The process may be carried out without the use of any further compounds selected from the group consisting of EDTA, EDDHHA, HEDTA, EDDHA, OTPA, multi-walled carbon nanotubes (MWCNTs), hydroxyfullerenes, iron dioxide (FeO₂), silver nanoparticles (AgNPs), silicon dioxide (SiO₂), titanium dioxide (TiO₂), silver oxides, catalysts, dispersants, nano-additives and preservatives, or mixtures thereof, while not impairing the technical effect thereof.

The process can easily be carry out either at lab scale or at industrial scale using known appropriate devices, vessels and element sources, especially for milling and blending, and temperature control.

The invention also relates to a use of the nano-chelated complexes of the invention as fertilizers.

Further specific non limitative examples are given with accompanying figures, wherein,

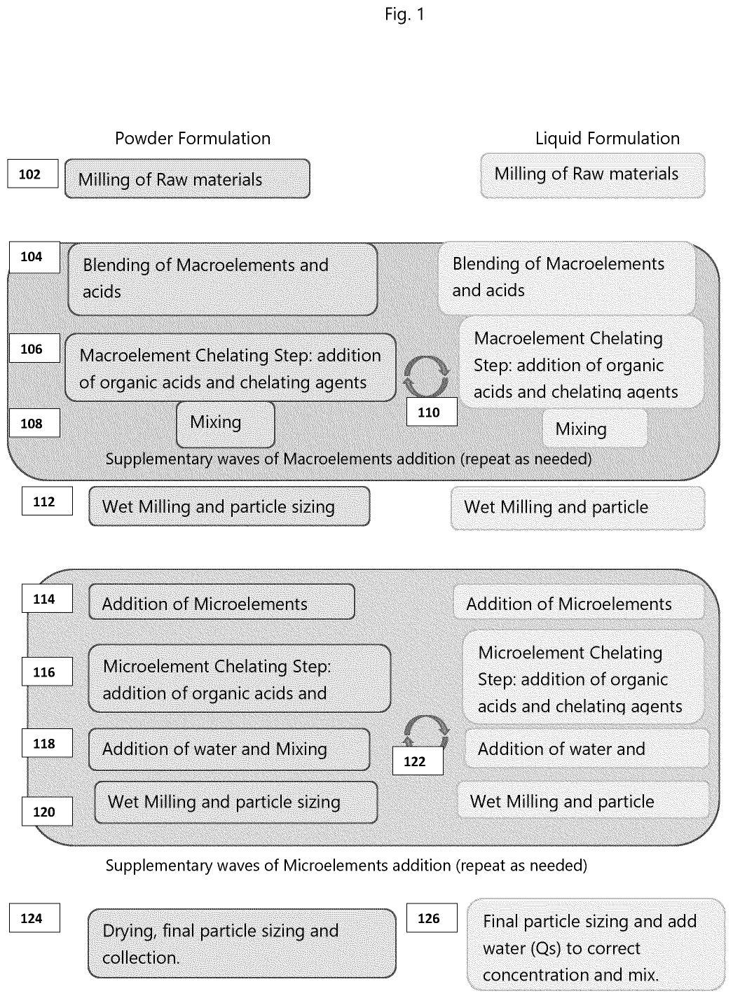

FIG. 1 schematically depicts various steps of the process according to an embodiment of the invention,

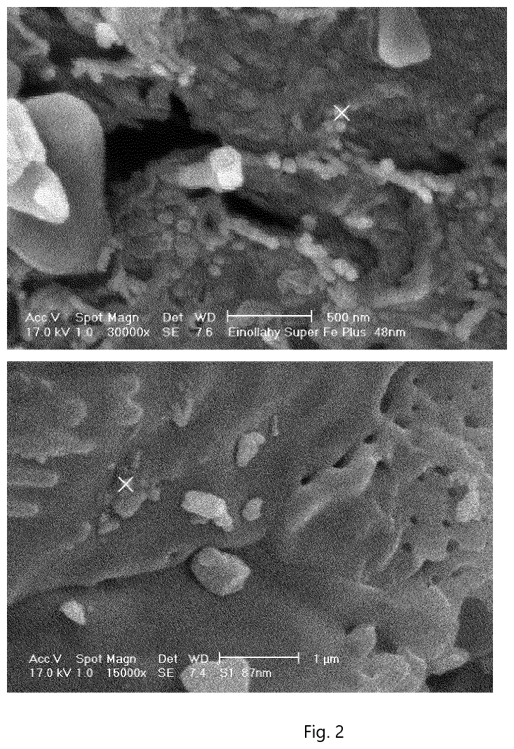

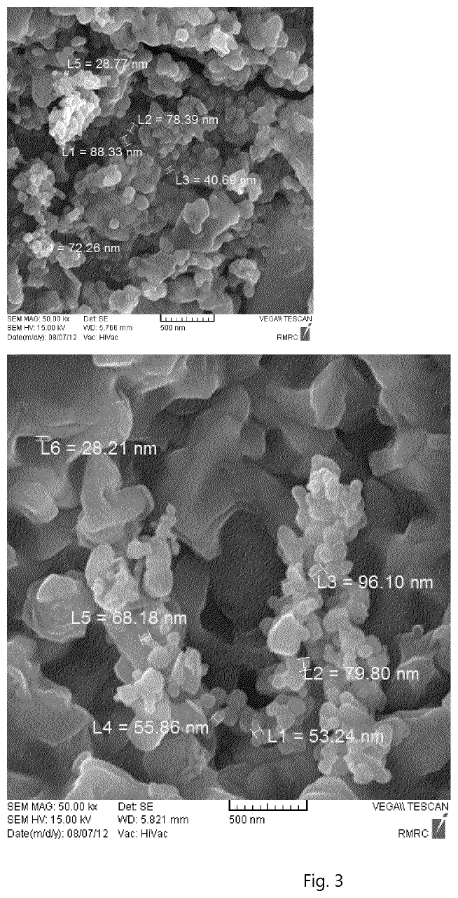

FIG. 2 and FIG. 3 depict a respective view of some nano-chelated complexes by Scanning Electronic Microscope,

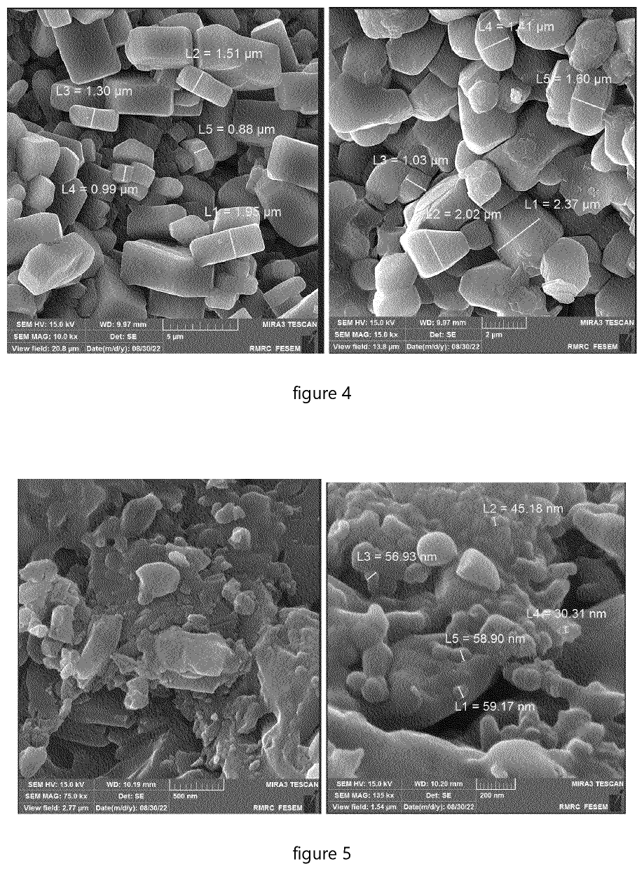

FIG. 4 depicts views of nano-chelated complexes obtained through milling steps performed at the end of step c) (step b) being omitted), by Scanning Electronic Microscope (comparative example not according to the invention),

FIG. 5 depicts views of nano-chelated complexes obtained through milling steps according to the invention, by Scanning Electronic Microscope

### 1) EXAMPLE 1

FIG. 1 schematically depicts various steps of the process according to an embodiment of the invention.

Step 102: Initial step of milling each of the raw materials, i.e. the at least one polycarboxylic acid, the first source material(s), here macroelement(s), the second source material(s), here micro-elements, to obtain particles presenting sizes of about 100 nm-300 nm.

Step 104: blending the starting raw materials, i.e polycarboxylic acid(s) independently of first source material(s).

Steps 106-108—step a): adding a predetermined quantity of at least one polycarboxylic acid into a predetermined quantity of at least one first source material providing at least one first cationic compound selected from the group consisting of nitrogen (N), phosphorus (P), potassium (K), magnesium (Mg), calcium (Ca), and zinc (Zn), based compounds, or mixtures thereof, and mixing the whole, thereby forming a chelate complex core compounds made of polycarboxylic acids incorporating at least one first cationic compound therein. Upon need, some water could be added for promoting the chelation reaction.

Step 110: steps 106-108, step a), are repeated, upon need, for the successive chelation of various macroelements.

Step 112: Step b), relates to the milling and the particle sizing of said chelate complex core compounds, preferably through wet milling. This step can be repeated until the desired particle size of below 150 nm is achieved.

Steps 114-118, step c): addition of a predetermined quantity of at least one second source compound of at least one second cationic compound, said second cationic compound being selected from the group consisting of nitrogen (N), phosphorus (P), potassium (K), magnesium (Mg), calcium (Ca), silicon (Si), iron (Fe), zinc (Zn), manganese (Mn), copper (Cu), boron (B), molybdenum (Mo), selenium (Se), cobalt (Co), sodium (Na), nickel (Ni), iodine (I), strontium (Sr), chromium (Cr) and organic carbon (OC) based or containing compounds, with a predetermined quantity of at one additional polycarboxylic acid, or mixtures thereof, to the chelate complex core compounds, and of mixing thereof, and further addition of water, resulting in a nano-chelated complexes mixture.

Step 120, step d), milling and particle sizing of the mixture obtained in step b) thereby forming nano-chelated complexes, wherein particle size thereof is ≤100 nm

Step 122: step 120, step d), is repeated multiple times until the concentration of the added second cationic compounds are achieved and uniformly coated, until the blend appears to be uniform (visual observation, powder uniformity testing).

Steps 124-126: steps e) and f), drying of the powder and final particle sizing of the powder of the nano-chelated complex. The product is processed until stable nano-chelated complexes are achieved, with particle size being lower than 100 nm. The final powder is then be collected and stored for future packaging operations. The final nano-chelated complexes undergo further purification step(s) (step f) through filtration, sieving, crystallization and centrifugation with known and classical devices.

Step 126: after step f), a further step describes of final particle sizing of the chelated complexes powder through additional wet milling. The product is processed until stable nano-chelated complexes are achieved, with particle size being lower than 100 nm. The final powder is then collected, transferred into mixing vessels and quantum satis (QS) with water for storage at a correct/desired concentration. Step 126 allows the preparation of the final nano-particles in liquid medium.

During the manufacturing process, several in-process tests are performed, such as particle size distribution, pH, content uniformity, relative humidity (RH) and powder fluidity. Following the manufacturing of the nano-chelate, samples are sent to a GLP Certified Lab for final testing and generation of a Certificate of Analysis. All performed tests follow ASTM, OECD and ISO Standards. The test conducted are among others appearance, appearance in solution, density, solubility, pH, powder flowability, mineral/element concentration and heavy metal concentrations. Some of specific laboratory methods used to assess product quality are; ISO/IEC 17025, ASTM D1217, OECD-105, OECD-122, OECD-109, ISO 22036-2008, OECD-120, ISO 11885/ESB. All laboratory methods used to characterize the nano-chelate complexes produced are qualified and validated.

### 2) Example 2: Preparation a Powder of Nano-Chelated Complexes Including Phosphorous as Chelate Complex Core, Iron 10 wt % (Bioavailable Wt %) Enriched with 7 Elements

The first step is a milling step of each material separately until they are between 100 nm and 300 nm: first and second source materials and polycarboxylic acids, materials described hereunder.

The milling step is followed by an addition of phosphoric anhydride with malic acid. Gradually water is added, then the whole is mixed, until mixture looks like a heavy paste (mixture 1).

Further, triple superphosphate (TSP) with tartaric acid are added to the previous blend (mixture 1), followed by blending until mixture is uniform (mixture 2).

To mixture 2, di-ammonium phosphate with succinic acid are added, then the whole is mixed. To the blend, water is added and mixed until mixture is uniform (mixture 3).

To mixture 3, mono-ammonium phosphate with citric acid are added, then the whole is mixed, leading to the creation of the chelate complex core blend (blend 1), having phosphorous embedded in malic acid, tartaric acid, succinic acid, citric acid, used.

The previous chelate complex core blend is wet milled to provide particles size of below 150 nm.

Further, to the considered chelate complex core blend, the following compounds are added successively:
potassium oxide, potassium sulfide and potassium nitrate with oxalic acid,
magnesium oxide, magnesium sulfide and magnesium nitrate with lactic acid,
calcium oxide and calcium sulfide calcium nitrate with malic acid and tartaric acid,
   with blending at each sub-step and wet milling to provide particles size of below 150 nm.

Obtained are chelate complex core blends (blend 2), having phosphorous, potassium, magnesium, calcium embedded in malic acid, tartaric acid, succinic acid, citric acid, oxalic acid and lactic acid.

The weight ratio polycarboxylic acid(s): first source material(s) is of from 2:1 to 1:3.

Blend 2 is wet milled until particle sizes are below 100 nm.

To blend 2, microelements are added (based on the second source elements): iron oxide, iron sulfide and iron nitrate with water, and then succinic acid and butanetetracarboxylic acid and oxalic acid and malic acid, then the whole is mixed leading to nano-chelated complexes including phosphorous as core chelate complex, enriched with iron 10 wt % (bioavailable wt %) (blend A).

Blend A is wet milled until particle sizes are below 100 nm.

Further, to blend A, the following compounds are added successively:
zinc oxide, zinc sulfide and zinc nitrate with water and butanetetracarboxylic acid and tartaric acid,
copper oxide, copper sulfide and copper nitrate with itaconic acid,
   with blending at each sub-step and wet milling to provide particles size of below 100 nm having 7 cationic compounds.

The weight ratio between the chelate complex core(s): second source material(s) is of from 2:1 to 1:3.

All steps are performed with controlled temperatures of between 27 to 35° C. These steps are repeated in a gradual stages until drying is complete and the target particle size is achieved.

At each stage, powder flow, moisture (RH), and temperature (27° C.-35° C.) are tested.

TABLE A

| Macro-and micro- | Theoretical | Measured |
|---|---|---|
| elements | bioavailable % | bioavailable % |
| Fe | 10 | [8.0-12] |
| P | 4 | [3.0-5.0] |
| K | 2 | [1.5-3.0] |
| Zn | 3 | [2.5-4.0] |
| Ca | 3 | [2.0-4.0] |
| Cu | 0.5 | [0.4-0.8] |
| Mg | 5 | [4.0-6.0] |

Heavy metals Cd, Co, Hg, are lower than 2 ppm, Ni and Pb are lower than 27 ppm.

The bioavailable (free-ion) wt % are determined according to ASTM, OECD or ISO standard analytical methods and/or using a validated laboratory spectroscopy device (i.e. Perkin-Elmer ELAN 6000 ICP-OES). Some of specific laboratory methods used to assess product quality are; ISO/IEC 17025, ASTM D1217, OECD-105, OECD-122, OECD-109, ISO 22036-2008, OECD-120, ISO 11885/ESB.

In the case of the example mentioned above, the obtained nano-chelated complex presents:
A dark purple crystalline powder;
Appearance in liquid: Clear dark red liquid;
Density: 1.1 g/cm³ (measured using a pycnometer);
Freely soluble (OECD-105);
pH: 1.8 (OECD-122), Ion/pH meter.

It should be emphasized that the pH, powder flow properties, solubility and the cationic compounds concentration in polycarboxylic acids are key characteristics to determine the nano-chelated complexes stability.

FIG. 2 shows the obtained nano-chelated complexes structures.

It has been demonstrated over and over that when performing the process using initial predetermined quantities of polycarboxylic acids, first and second source materials as given higher, there is a very good correlation between the expected values and those obtained by GLP Laboratory.

### 3) Example 3: Preparation a Powder of Nano-Chelated Complexes Including Nitrogen as Chelate Complex Core, Enriched with Zn, Ca, Mg

The first step is a milling step of each material separately until they are between 100 nm and 300 nm: first and second source materials and polycarboxylic acids, materials described hereunder.

The milling step is followed by an addition of urea with oxalic acid. Gradually add water, then the whole is mixed, until mixture looks like a heavy paste (mixture 1).

The previous chelate complex core compounds (mixture 1) is wet milled to provide particles size of below 150 nm.

To the previous blend (mixture 1), phosphoric anhydride, triple superphosphate (TSP) di-ammonium phosphate and mono-ammonium phosphate with malic acid are added, the whole being mixed (mixture 2).

To mixture 2, potassium oxide, potassium sulfide and potassium nitrate with succinic acid are added, mix until uniform (mixture 3).

To mixture 3, magnesium oxide, magnesium sulfide and magnesium nitrate with malic acid are added, then mixed for 10 min (mixture 4).

To mixture 3, calcium oxide, calcium sulfide, calcium nitrate with tartaric acid are added, and then mixed until uniform.

The previous chelate complex core blend is wet milled to provide particles size of below 150 nm. A drying step may be included after each addition step.

Obtained are chelate complex core blends having nitrogen, phosphorous, potassium, magnesium, calcium embedded in malic acid, tartaric acid, succinic acid and oxalic acid.

Further, to the considered chelate complex core blend, the following micro-elements are added successively (based on the second source materials):
iron oxide, iron sulfide and iron nitrate with water and then succinic acid and butanetetracarboxylic acid, then mixed until uniform;
zinc oxide, zinc sulfide and zinc nitrate with water and then itaconic acid and tartaric acid, then mixed until uniform;
manganese oxide, manganese sulfide and manganese nitrate with malic acid and tartaric acid, then mixed until uniform;
copper oxide, copper sulfide and copper nitrate with lactic acid, then mixed until uniform;
molybdenum oxide and malic acid, then mixed, boron oxide, then mixed until uniform.

Drying, which could be carried out after each step, and wet milling steps are performed in temperatures between 27 to 35° C. These steps are repeated in a gradual stages until drying is complete and the target particle size of less than 100 nm is achieved.

The nano-chelates complexes include 11 macro- and micro-elements.

The weight ratio between the chelate complex core(s): second source material(s) is of from 2:1 to 1:3.

At each stage, powder flow, moisture (RH), and temperature (27° C.-35° C.) are tested.

TABLE B

| Macro-and micro- | Theoretical | Measured |
|---|---|---|
| elements | bioavailable % | bioavailable % |
| Fe | 4.5 | [3.5-5.5] |
| N | 5 | [4.0-6.0] |
| K | 3 | [2.5-4.0] |
| Zn | 8 | [6.5-9.5] |
| Ca | 6 | [4.5-7.5] |
| Cu | 0.65 | [0.5-0.8] |
| Mg | 6 | [5.0-7.0] |
| Mn | 0.8 | [0.6-1.2] |
| P | 3 | [2.5-3.5] |
| Mo | 0.1 | [0.08-2.0] |
| B | 0.65 | [0.5-1.0] |

Heavy metals Cd, Co, Hg, are lower than 2 ppm, Ni is lower than 100 ppm, and Pb are lower than 11 ppm.

The bioavailable (free-ion) wt % are determined according to ASTM, OECD or ISO standard analytical methods and/or using a validated laboratory spectroscopy device (i.e. Perkin-Elmer ELAN 6000 ICP-OES). Some of specific laboratory methods used to assess product quality are; ISO/IEC 17025, ASTM D1217, OECD-105, OECD-122, OECD-109, ISO 22036-2008, OECD-120, ISO 11885/ESB. All laboratory methods used to characterize the nano-chelate complexes produced are qualified and validated.

In the case of the example mentioned above, the obtained nano-chelated complex presents:
A dark purple crystalline powder;
Appearance in liquid: Clear dark red liquid;
Density: 1.1 g/cm³ (measured using a pycnometer);
Freely soluble (OECD-105);
pH: 1.8 (OECD-122), Ion/pH meter.

It should be emphasized that the pH, powder flow properties, solubility and the cationic compounds concentration in polycarboxylic acids are key characteristics to determine the nano-chelated complexes stability.

FIG. 3 shows the obtained nano-chelated complexes structures.

It has been demonstrated over and over that when performing the process using initial predetermined quantities of polycarboxylic acids, first and second source materials as given higher, there is a very good correlation between the expected values and the GLP Laboratory obtained ones.

### 4) Example 4

A study was carried out to assess the effects of the foliar application of nano-fertilizers of zinc (Zn) and boron (B) of the invention on pomegranate (Punica granatum cv. Ardestani) fruit yield and quality.

A factorial experiment was conducted based on a completely randomized block design, with nine treatments and four replications per treatment. Foliar sprays of nano-Zn chelate fertiliser at three concentrations (0, 60 and 120 mg Zn L⁻¹) and nano-B chelate fertiliser (0, 3.25 and 6.5 mg B L⁻¹) were applied as a single spray before full bloom at a rate of 5.3 L tree⁻¹. The application of Zn and B increased the leaf concentrations of both microelements in August, reflecting the improvements in tree nutrient status. A single foliar spray with relatively low amounts of B or Zn nano-fertilizers (34 mg B tree⁻¹ or 636 mg Zn tree⁻¹, respectively) led to increases in pomegranate fruit yield, and this was mainly due to increases in the number of fruits per tree. The effect was not as large with Zn as with B. Fertilization with the highest of the two doses led to significant improvements in fruit quality, including 4.4-7.6% increases in TSS, 9.5-29.1% decreases in TA, 20.6-46.1% increases in maturity index and 0.28-0.62 pH unit increases in juice pH, whereas physical fruit characteristics were unaffected (see Tables 1-4). Changes in total sugars and total phenolic compounds were only minor, whereas the antioxidant activity and total anthocyanins were unaffected.

TABLE 1
Effects of nano-Zn and -B foliar fertilizers on leaf mineral composition
(n = 3). Data shown are means of the seasons, except for N.

| Treatment | N*(%) | P(%) | K(%) | Ca(%) | Mg(%) | Fe(mg/kg) | Zn(mg/kg) | B(mg/kg) | Mn(mg/kg) | Cu(mg/kg) |
|---|---|---|---|---|---|---|---|---|---|---|
| Zn0 + B0 | 1.84 a | 0.10 a | 0.85 e | 2.31 a | 0.358 a | 112.0 a | 13.3 e | 21.1 b | 71.3 a | 7.1 a |
| Zn1 + B0 | 1.87 a | 0.10 a | 0.89 cde | 2.47 a | 0.344 abcd | 114.7 a | 15.7 cde | 21.3 b | 70.2 a | 7.0 a |
| Zn2 + B0 | 1.86 a | 0.10 a | 0.98 ab | 2.44 a | 0.323 cde | 115.2 a | 17.6 bc | 21.7 b | 66.2 a | 6.5 a |
| Zn0 + B1 | 1.85 a | 0.10 a | 0.87 de | 2.42 a | 0.350 ab | 116.8 a | 14.7 de | 22.3 b | 70.1 a | 7.0 a |
| Zn1 + B1 | 1.91 a | 0.11 a | 0.94 abc | 2.49 a | 0.346 abc | 113.8 a | 18.2 bc | 23.0 b | 66.6 a | 6.7 a |
| Zn2 + B1 | 1.95 a | 0.11 a | 1.00 a | 2.38 a | 0.340 abcd | 114.7 a | 21.4 a | 22.9 b | 66.8 a | 6.5 a |
| Zn0 + B2 | 1.85 a | 0.11 a | 0.91 bcd | 2.39 a | 0.320 de | 110.0 a | 16.4 cd | 25.3 a | 69.2 a | 6.4 a |
| Zn1 + B2 | 1.88 a | 0.11 a | 0.96 ab | 2.46 a | 0.330 bcde | 111.0 a | 17.9 bc | 25.0 a | 68.0 a | 6.9 a |
| Zn2 + B2 | 1.90 a | 0.11 a | 0.98 ab | 2.40 a | 0.311 e | 106.8 a | 19.6 ab | 25.1 a | 66.8 a | 7.0 a |

Zn0, Zn1 and Zn2 are 0, 60 and 120 mg ZnL⁻¹, and B0, B1 and B2 are 0, 3.25 and 6.5 mg BL⁻¹, respectively. Means with the same letter in each column were not significantly different using Duncan's multiple range test at p < 0.05.
*Data for N are only for the season 2014.

According to the results of this Table 1, when zinc and boron elements are used in nano form, it shows that with the use of zinc nano-chelates, the percentage of zinc element in the leaf has increased. This table also shows the improved effect of different amounts of zinc and boron on the absorption of other elements.

TABLE 2
Effects of nano-Zn and -B foliar fertilizers on pomegranate fruit yield, number
of fruits per tree, fruit cracking, fruit diameter and length, fruit calyx
diameter and fruit average weight. Data shown are means of the two years.

| | Yield | Number | | Fruit | Fruit | Fruit | Fruit |
|---|---|---|---|---|---|---|---|
| | (kg per | of fruits | Fruit | diameter | length | calyx | average |
| Treatment | tree) | per tree | cracking | (mm) | (mm) | diameter (mm) | weight (g) |
| Zn0 + B0 | 13.8 e | 50.6 d | 3.1 a | 75.5 abc | 79.9 a | 20.0 a | 272.8 a |
| Zn1 + B0 | 14.3 de | 52.7 cd | 2.8 a | 76.5 abc | 77.8 a | 20.9 a | 272.2 a |
| Zn2 + B0 | 15.8 bc | 57.6 bc | 2.8 a | 77.7 ab | 77.9 a | 20.2 a | 274.5 a |
| Zn0 + B1 | 14.4 de | 52.2 cd | 2.9 a | 73.2 c | 80.1 a | 20.4 a | 274.9 a |
| Zn1 + B1 | 15.0 cd | 51.3 d | 2.6 a | 78.2 ab | 81.7 a | 20.7 a | 292.8 a |
| Zn2 + B1 | 16.2 b | 58.7 b | 2.5 a | 76.6 abc | 79.0 a | 20.9 a | 276.6 a |
| Zn0 + B2 | 18.0 a | 64.4 a | 2.6 a | 74.2 bc | 80.5 a | 20.4 a | 279.7 a |
| Zn1 + B2 | 18.5 a | 65.9 a | 2.5 a | 74.9 abc | 80.2 a | 19.6 a | 281.1 a |
| Zn2 + B2 | 18.4 a | 63.0 ab | 2.8 a | 78.8 a | 81.6 a | 21.2 a | 291.9 a |

Significance

| | | | | | | | |
|---|---|---|---|---|---|---|---|
| Zn | ** | * | NS | * | NS | NS | NS |
| B | ** | ** | NS | NS | NS | NS | NS |
| Zn*B | * | * | NS | NS | NS | NS | NS |
| year | ** | NS | NS | ** | ** | ** | ** |

Zn0, Zn1 and Zn2 are 0, 60 and 120 mg ZnL⁻¹, and B0, B1 and B2 are 0, 3.25 and 6.5 mg BL⁻¹, respectively. Means with the same letter in each column were not significantly different using Duncan's multiple range test at p < 0.05.
*, ** and NS are significant at p ≤ 0.05, at p ≤ 0.01 and not significant, respectively.

According to the results of this Table 2, tree yield, number of fruits per tree and fruit cracking, foliar spraying of Zn and B fertilizers, alone or combined, increased significantly fruit yield (depending on the regimen). Both B and Zn fertilization seem to have an effect on yield, but with B the effect was more pronounced. The highest yields (18.0-18.5 kg tree⁻¹) were obtained with the Zn0+B2, Zn1+B2 and Zn2+B2 treatments, which led to 30.4-34.0% increases when compared with the control one (13.8 kg tree-1). The application of Zn and B led to significant increases in the number of fruits per tree (by 13.8-30.2%, depending on the treatments).

TABLE 3
Effects of nano-Zn and -B foliar fertilizers on pomegranate fruit aril and
peel percentages, aril/peel radio, weight of 100 arils, juice content of
100 g arils and peel thickness. Data shown are means of the two years.

| | | | | | Juice | |
|---|---|---|---|---|---|---|
| | | | | Weight of | content | Peel |
| | Total | Total | Aril/peel | 100 aril | of 100 g | thickness |
| Treatment | aril (%) | peel (*) | ratio | (g) | arils (ml) | (mm) |
| Zn0 + B0 | 57.6 a | 42.4 a | 1.36 a | 36.6 a | 62.1 a | 2.44 a |
| Zn1 + B0 | 57.0 a | 43.0 a | 1.32 a | 36.7 a | 62.3 a | 2.51 a |
| Zn2 + B0 | 56.0 a | 44.0 a | 1.27 a | 37.6 a | 63.1 a | 2.56 a |
| Zn0 + B1 | 57.7 a | 42.3 a | 1.36 a | 36.6 a | 62.6 a | 2.41 a |
| Zn1 + B1 | 56.0 a | 44.0 a | 1.27 a | 37.2 a | 63.3 a | 2.57 a |
| Zn2 + B1 | 55.9 a | 44.1 a | 1.26 a | 38.8 a | 62.6 a | 2.57 a |
| Zn0 + B2 | 56.2 a | 43.8 a | 1.28 a | 36.6 a | 62.1 a | 2.51 a |
| Zn1 + B2 | 55.9 a | 44.1 a | 1.26 a | 37.3 a | 62.9 a | 2.61 a |
| Zn2 + B2 | 55.5 a | 44.5 a | 1.24 a | 37.7 a | 62.9 a | 2.64 a |

Significance

| | | | | | | |
|---|---|---|---|---|---|---|
| Zn | NS | NS | NS | NS | NS | NS |
| B | NS | NS | NS | NS | NS | NS |
| Zn*B | NS | NS | NS | NS | NS | NS |
| year | NS | NS | NS | NS | NS | NS |

Zn0, Zn1 and Zn2 are 0, 60 and 120 mg ZnL⁻¹, and B0, B1 and B2 are 0, 3.25 and 6.5 mg BL⁻¹, respectively. Means with the same letter in each column were not significantly different using Duncan's multiple range test at p < 0.05.
*, ** and NS are significant at p ≤ 0.05, at p ≤ 0.01 and not significant, respectively.

According to this table 3, zinc and boron elements have not been effective in increasing the peel thickness. Because increasing the thickness of the peel and improving it mostly linked to specialized effects of the role calcium in fruit development.

TABLE 4
Effects of nano-Zn and -B foliar fertilizers on pomegranate fruit juice pH, TSS, TA, maturity index, total
phenols, antioxidant activity, total sugars and total anthocyanins. Data shown are means of the two years

| | | | | Maturity | Total | | | Total |
|---|---|---|---|---|---|---|---|---|
| | | | | index | phenols | | Total sugars | anthocyanins |
| | | | | (TSS/TA | (mg 100 | Antioxidant | (g 100 | (mg 100 |
| Treatment | Juice pH | TSS (%) | TA(%) | ratio) | g⁻¹ FW) | activity (%) | g⁻¹ FW) | g⁻¹ FW) |
| Zn0 + B0 | 3.42 e | 15.85 d | 1.89 a | 8.49 c | 406.64 e | 23.88 a | 14.26 d | 7.69 a |
| Zn1 + B0 | 3.55 de | 15.97 d | 1.81 ab | 8.85 c | 406.92 de | 24.17 a | 14.28 d | 7.76 a |
| Zn2 + B0 | 3.70 cd | 16.30 cd | 1.59 c | 10.24 b | 408.09 bcde | 25.72 a | 14.43 bcd | 8.20 a |
| Zn0 + B1 | 3.53 de | 15.96 d | 1.71 bc | 9.43 bc | 407.74 cde | 24.3 a | 14.37 cd | 8.01 a |
| Zn1 + B1 | 3.73 c | 16.26 cd | 1.43 d | 11.51 a | 407.56 cde | 24.98 a | 14.54 bc | 7.86 a |
| Zn2 + B1 | 4.04 a | 16.96 ab | 1.37 d | 12.37 a | 408.60 bcde | 26.41 a | 14.63 b | 8.66 a |
| Zn0 + B2 | 3.83 bc | 16.14 cd | 1.39 d | 11.71 a | 408.77 abc | 26.11 a | 14.43 bcd | 8.51 a |
| Zn1 + B2 | 3.99 ab | 16.56 bc | 1.34 d | 12.34 a | 409.48 ab | 26.72 a | 14.60 bc | 8.73 a |
| Zn2 + B2 | 3.98 ab | 17.06 a | 1.37 d | 12.41 a | 409.92 a | 29.48 a | 14.93 a | 8.68 a |

Significance

| | | | | | | | | |
|---|---|---|---|---|---|---|---|---|
| Zn | ** | ** | ** | ** | * | NS | ** | NS |
| B | ** | ** | ** | ** | ** | NS | ** | NS |
| Zn*B | * | NS | * | * | NS | NS | NS | NS |
| year | NS | NS | NS | NS | NS | NS | NS | NS |

Zn0, Zn1 and Zn2 are 0, 60 and 120 mg ZnL⁻¹, and B0, B1 and B2 are 0, 3.25 and 6.5 mg BL⁻¹, respectively. Means with the same letter in each column were not significantly different using Duncan's multiple range test at p < 0.05.
*, ** and NS are significant at p ≤ 0.05, at p ≤ 0.01 and not significant, respectively.
FW: fresh weight

According to this Table 4, Pomegranate juice pH increased significantly (by 0.28-0.62 pH units, depending on the regimen). Also, the more concentrated B and Zn within the regimen, the higher the increase of TSS in juice (4.4-7.6%), with the highest and lowest TSS values (17.06 and 15.85%, respectively) being observed in trees treated by the highest concentrations of Zn and B (Zn2+B2) versus the untreated controls, respectively (Table 4). Regarding TA, all regimen, with the exception of Zn1+B0, showed values lower than the controls (9.5-29.1% decreases, depending on the regimen), with the lowest one being for the treatment Zn1+B2 (Table 4). As a result, B and Zn fertilization markedly increased the maturity index (TSS/TA ratio), by 20.6-46.1%, depending on the regimen, due to the increases in TSS and decreases in TA (Table 4). The highest increase in the maturity index was obtained in the trees sprayed with the regimen Zn2+B2, followed by the treatments Zn2+B1 and Zn1+B2.

The important point in the above tables (Tables 1-4) is to observe the synergistic effects of zinc and boron, in its nano-chelated form, and to use appropriate ratios during foliar application. This study demonstrates the effect of how to consume and follow the principles of nutrition in achieving the optimal effectiveness. Zinc and boron in combination synergistically improve the qualitative and quantitative properties of fruits and crops.

### 5) Example 5

Based on the studies from the experiment, it is known that the soil of the nano chelated complexes (micro fertilizers) has a high natural fertility, with a mildly alkaline/neutral reaction of soil solutions. In addition, the biologically active iron nanoparticles allow for an increase in yield capacity of some cereal crops ranging from 10-40%. These properties indicate the soils richness in nutritional elements, thus making the nano chelated complexes favourable for crop plants. The properties of nano chelated complexes promote growth and development of plants.

### Sugar Beet Plant Example

In this experiment, the Control received N₁₂₀P₉₀K₁₃₀ kg/ha active ingredient of mineral fertilizers during soil tillage. The latter regimen represents the normal sugar beet cultivation practices in the region. KRNV-5,6-02 cultivator was used in the inter-row spaces prior to leaf closure.

The experimental group followed a foliar application of the nano-chelated fertilizers;

TABLE 5
Foliar application regimen of nano-chelated fertilizers (stage, concentration,
application rate) having particle sizes of less than 100 nm

| Application stage | Nano fertilizers | Concentration | Application rate | |
|---|---|---|---|---|
| 1 | Nano Chelate Fertilizer Phosphorous 25% | 1 kg/400 l | 2 | kg/ha |
| | NanoChelate fertilizer Super Micro Plus | 1 kg/500 l | 2 | kg/ha |
| | Nano Chelate Fertilizer Zinc 20% | 1 kg/1,000 l | 1 | kg/ha |
| 2 | Nano Chelate Fertilizer Potassium 23% | 1 kg/400 l | 3 | kg/ha |
| | Nano chelate Fertilizer Manganese 25% | 2 kg/2,000 l | 1 | kg/ha |
| | Nano Chelate FertilizerCopper 15%** | 1 kg/1,000 l | 1 | kg/ha |
| | NanoChelate Fertilizer Enriched Iron 10%* | 1 kg/400 l | 1 | kg/ha |
| 3 | Nano chelates Fertilizer Magnesium 25% | 1 kg/500 l | 2 | kg/ha |
| | Nano chelate Fertilizer Super Micro Plus | 1 kg/400 l | 2 | kg/ha |
| | Nano Chelate Fertilizer Calcium 25% | 2 l/1,000 l | 1,000 | l/ha |

*The fertilizer was applied on the next day (not earlier than after 24 hours).
**The fertilizer is not mixed with the other ones in a solution, but is applied separately.

The incorporation of the nano chelate compounds (fertilizers) positively impacted the foliar nutrition and promoted the extension of photosynthetic plant mechanism functioning, as revealed through the leaf masses ability to maintain freshness and its green color for longer durations of time compared to the control groups. The use of said fertilizers increases the crop capacity of the beet plant and improved the quality, in regard to nutrients, of the said fruit. The fertilizers resulted in:
Growth and development of plants
Increase of sugar and beet root mass accumulation intensity
Strengthening of root system and active gain of vegetative mass
Improvement of plant resistance against diseases
Increase of beet root mass and size
Yield capacity increase up to 30.9%
Sugar content increase in beet roots up to 7.6%
Extension of beet root preservation period

TABLE 6
Productivity of sugar beets during application of the fertilizers.

| | | Variant without |
|---|---|---|
| | Variant with nano- | application |
| Index | chelate fertilizers | (Control) |
| Yield capacity, t/ha | 76.6 | 58.5 |
| Sugar content, (overall sugar), % | 18.3 | 17.0 |
| Sugar content, (pure sugar), % | 16.2 | 14.6 |
| Sugar recovery factor (extraction) | 88.52 | 85.88 |
| Molasses, % | 3.8 | 4.4 |
| Sugar harvesting, t/ha | 12.41 | 8.54 |

### Conclusion

The foliar application of nano-chelate fertilizers is effective for increasing the crop capacity and improving the quality indices of agricultural crop products because:
Nano Chelate Fertilizer Phosphorus 25% increases the resistance against diseases, balances the nitrogen fertilizer effect, increases the crop yield capacity up to 9.5%; increases sugar content in beet roots up to 3.5% and sugar harvesting up to 14.8%.
Nano chelates fertilizer Super Micro Plus (eleven element multi nano-chelate) promotes the accumulation of high sugar amount in beet roots, increases the resistance of plants against diseases, increases the crop yield capacity up to 6.1%; increases sugar content in beet roots up to 4.7% and sugar harvesting up to 12.7%.
Nano Chelate Fertilizer Zinc 20% promotes photosynthesis and chlorophyll synthesis processes, increases the resistance of plants against diseases, increases the crop yield capacity up to 8.0%; increases sugar content in beet roots up to 2.0% and sugar harvesting up to 14.7%.
Nano Chelate Fertilizer Potassium 23% promotes photosynthesis and chlorophyll synthesis processes, increases the resistance of plants against diseases, increases the crop yield capacity up to 3.4%; increases sugar content in beet roots up to 3.5% and sugar harvesting up to 7.7%.
Nano Chelates fertilizer Manganese 25% makes an impact on increasing chlorophyll content, improves sugar release from leaves, increases the breathing intensity, rises water-holding capacity of tissues, reduces transpiration, promotes synthesis and sugar content increase, increases the crop yield capacity up to 8.3%; increases sugar content in beet roots up to 4.7% and sugar harvesting up to 15.8%.
Nano Chelate Fertilizer Copper 15% increases resistance against fungous and bacterial diseases, improves drought and heat resistance of plants, promotes the better nitrogen absorption, synthesis and sugar content increase, increases the crop yield capacity up to 6.6%; increases sugar content in beet roots up to 5.3% and sugar harvesting up to 13.2%.
Nano Chelate Fertilizer Enriched Iron 10% increases resistance against fungous and bacterial diseases, improves drought and heat resistance of plants, promotes the better nitrogen absorption, synthesis and sugar content increase, increases the crop yield capacity up to 10.6%; increases sugar content in beet roots up to 3.5% and sugar harvesting up to 17.4%.
Nano Chelate Fertilizer Magnesium 25% increases resistance against fungous and bacterial diseases, improves drought and heat resistance of plants, promotes the better nitrogen absorption, synthesis and sugar content increase, increases the crop yield capacity up to 12.1%; increases sugar content in beet roots up to 2.3% and sugar harvesting up to 19.0%.
Nano Chelate Fertilizer Calcium 25% improves heat resistance of plants, removes toxic effect of some microelements (copper, iron and zinc), promotes the better transportation of carbohydrates and protein substances, chlorophyll synthesis, beet root growth, synthesis and sugar content increase, increases the crop yield capacity up to 5.6%; increases sugar content in beet roots up 2.0% and sugar harvesting up to 12.2%.

The combined use of fertilizers promotes the growth and development of plants; improves root system and active gaining of vegetative mass; extends the functioning of photosynthetic plant mechanism; increases the accumulation intensity of sugar, beet roots mass and size; increases the resistance of plants against diseases, the crop yield capacity up to 30.9%, sugar content in beet roots up to 7.6% (sugar beet) and promotes the extension of beet root preservation period.

The foliar nutrition of sugar beet plantings with a combination of Nano-chelate micro fertilizers is effective for increasing the crop capacity and improving the quality indices of agricultural crop products, and is also effective for the representatives of a beet root group, first of all the beet botanic species (Beta L.), which includes the representatives of Betacicia and Betacrassa subspecies: table beets (B. convar. cruenfa); fodder beets (B. convar. crassa), sugar beets (B. vulgaris saccharifera), salad leaf beets (B. convar. Vulgarly), salad stalked beets (B. convar. Petiolata), decorative stalked hybrid beets (B. convar. varioecila).

It is possible to expect the effectiveness from applying Nano-chelate micro fertilizers on the other crops: carrot, radish, turnip, rutabaga, parsley, parsnip, celery.

Fertilizers will make an effective impact on the crop capacity of other agricultural crops, whose morphological structure peculiarities and development are the same as those of the beet root group, especially the representatives of the tuber crop group: such as potato, Jerusalem artichoke, yam, taro, sweet potato (batata) and manihot.

### 6) Example 6

Pears: Nano-Chelated Complexes Fertilizers Vs. Control Group (without Fertilizer)

A study was performed to assess the impact of the nano-chelated complex fertilizer versus the traditional farming (without the use of chemical fertilizers). The objective of the study is to determine the net impact of the nano-chelated complex fertilizers on fruit trees.

The soil was analyses prior to the study to ensure no deficiencies are present and that it can support the healthy growth/development of fruit trees. The soil assessment was the following;

| INDEX | Test results |
|---|---|
| pH of salt extract, pH units | 7.8 |
| Humus substance (organic matter) % | |
| 0-51 cm | 5.1 |
| 51-90 cm | 3.9 |
| 90-138 cm | 2.7 |
| 138-180 cm | 1.3 |
| Nitrogen (alkalin-hydrolized), mg/kg | 202.4 |
| Mass content of Potassium mg/kg | 81.9 |
| Labile Phosphorus, mg/kg | 26.5 |
| Exchange Calcium, mmol/100 g | 7.2 |
| Exchange Magnesium, mmol/100 g | 1.3 |
| Carbonates, mmol/100 g | 0.1 |
| Bicarbonates, mmol/100 g | 0.55 |
| Mass content of Iron, mg/kg | 0.07 |
| Mass content of Manganese, mg/kg | 10.04 |
| Mass content of Copper, mg/kg | 0.14 |
| Mass content of Zink, mg/kg | 0.31 |

The use of the nano-chelated complex fertilizer followed the regimen;

TABLE 7

| | | | Dosage | | Dosage | | |
|---|---|---|---|---|---|---|---|
| | | | (spraying)/ | | (root | | |
| Stage | Treatment time | Fertilizer | 1000 L | | nutrition) | | Concentration |
| 1 | Budding | Nano Chelate Fertilizer Super Micro Plus | 0.5 | kg | — | | Concentration per |
| | | Nano Chelate Fertilizer Zinc 20% | 1 | kg | — | | 1000 liters during |
| | | Nano Chelate Fertilizer Nitrogen 20% | 1 | liter | — | | mixed application |
| 2 | Budding | Nano Chelate Fertilizer Phosphorus 25% | | | 20 | gr/tree | |
| | | Nano Chelate Fertilizer Potassium 23% | | | 30 | gr/tree | |
| | | Nano Chelate Fertilizer Nitrogen 20% | | | 60 | cc/tree | |
| | | Nano Chelate Fertilizer Super Micro Plus | | | 40 | gr/tree | |
| 3 | Petals falling | Nano Chelate Fertilizer Enriched Iron 10% | 1 | Kg | | | |
| 4 | Fruit setting | Nano Chelate Fertilizer Potassium 23% | 1 | kg | — | | Concentration per |
| | | Nano Chelate Fertilizer Nitrogen 20% | 1 | liter | — | | 1000 liters during |
| 5 | 2 weeks after | Nano Chelate Fertilizer Copper 15% | 1 | kg | — | | mixed application |
| | stage No. 4 | Nano Chelate Fertilizer Nitrogen 20% | 1 | liter | — | | |
| 6 | 2 weeks after | Nano Chelate Fertilizer Super Micro Plus | 1 | kg | | | |
| | stage No. 4 | Nano Chelate Fertilizer Manganese 25% | 1 | kg | | | |
| 7 | Beginning of | Nano Chelate Fertilizer Magnesium 25% | 1 | kg | | | |
| | fruit ripeness | Nano Chelate Fertilizer Nitrogen 20% | 1 | liter | | | |
| | (color change) | | | | | | |
| 8 | 1 month prior to | Nano Chelate Fertilizer Calcium 25% | 2 | liter | | | |
| | harvesting | | | | | | |

As described in the Table 7 above, a combination of multi-element and mono-element nano-chelate complex fertilizers was used. This was to show the interaction between the different products and to ensure supply of the necessary elements to the plant and crop at the stages where the nutrients are most needed. Each stage of the plant growth requires a precise set of nutrients in order to have optimal yield and crop nutritional content. For example, a balance of potassium and magnesium elements (in ionic forms) is important for healthy fruit color formation. The above Table 7 summarizes the program used in the study and highlights the need to supply potassium element in stage 4 (fruit setting) to obtain the optimal fruit color formation. To further ensure that optimal color is achieved, magnesium nano-chelate complex has been introduced during the beginning of ripeness (Stage 7), which is required to ensure that the color doesn't fade and minerals are crystallized in the fruit. The ability of this technology to allow targeted delivery of the required elements at the appropriate cycle stage is due to the very small particle size, low toxicity and increased surface area of the nano-chelated complexes compounds. The technology allows for tailor made and environmentally-friendly applications of fertilizers.

In addition, the reduced surface tension due to nano-particle size and organic acid presence within the nano-chelated complexes compounds, very low concentration of fertilizers can be used through foliar spraying applications. This causes the surface of leaves and fruit to be covered with the combination of fertilizer and water, where higher amounts of elements to be absorbed through leaves and plant organs. This factor makes it possible to satisfy the nutritional needs of plants by consuming a small amount of fertilizer during the important stages of physiological growth in the plant.

The addition of the fertilizers into the soil, through fertigation, allowed for both the promotion of reproductive buds setting, as well as an increased amount of flowers by 13.73%. In comparison to the control group, the fertilizers revealed a quantity of 762 pcs/tree as opposed to 670 pcs/tree. The increase of flowers has resulted in increasing the loading of fruits per tree by 20.99%, exhibiting a 6.38% increase. Analysing the size of the fruit, the weight of the pears harvested from trees treated with nano-chelate fertilizers exhibited a weight of 37-38 g at the beginning of filling, as opposed to the 20-23 g weight of the pears from the control group. In addition to the size, the average length of fruits grown with the fertilizer reached 106.3 with 81.5 mm, as opposed to the 78.3 with 66.5 mm reached on the control group. This finding proved the fertilized fruits exceeded the latter by 30.43 and 17.57%. As revealed during the picking maturity stage, the average weight of pear fruits was 154.2 g in the control group, yet the fertilized fruits showed an increase up to 196.0 g, thus exceeding the control group by 27.11%. In addition, the maximum weight of some of the fertilized fruits reached 235-299 g at the picking maturity stage.

The total output of top and first market-grade fruits can be summarized as follows;

TABLE 8

| | | | Total output of top and |
|---|---|---|---|
| | Yield capacity | | the first market-grade |
| Variant of experiment | kg/tree | t/ha | fruits, % |
| Control (without fertilizers) | 35.465 | 22.83 | 84.6 |
| Nano-chelated complexes | 48.281 | 29.95 | 86.7 |
| fertilizers | | | |
| Gain to the check plot, % | 36.14 | 31.19 | 2.48 |
| HIP 0.5 | 4.62 | 3.54 | — |

Nano-Chelated Complexes Fertilizers Vs. Control Group (without Fertilizer)

In addition to the increasing yield, results showed a significant increase in product quality with higher content of vitamins C and P (flavonoids) in the pear fruits, revealing an increase of 6.78% and 1.3%, respectively when compared to the control group. The sugar content of the pear fruits were higher with the fertilizers group, with an increase of 11.09% as opposed to the control. The fertilizers allowed the sugars to acids ratio to increase by 2 relative units (rel. units) and demonstrated an increase of 7.33% of soluble dry substances versus control. It was also noticed an improvement in the preservation characteristics, showing that fruits harvested with the fertilizers plots had an index of 1.37 to 1.39 times longer, when compared to control.

Through incorporating the fertilizers, the total output of top and first market-grade fruits from the pear trees reached the highest percentage of 86.7%. In comparison with the check plot, the fertilizers exhibited a 2.48% increase, as well as a decreased amount of non-standard products produced. In addition, the application of fertilizers resulted in the increase in sugar content, reaching a total of 10.62% as opposed to the 11.09% received from the control group. Exceeding the control group by 1.06%, the incorporation of the fertilizers allowed the sugars to acids ratio to increase by 2 relative units (rel. units) in the fertilization system. Through utilizing the fertilizers, results showed a significant increase in the vitamin C and P content in pear fruits, revealing an increase of 6.78 and 1.3% accordingly from the control group. The results of the study clearly show the nutritional effects caused by using macro and micro elements in helping the plants in achieving optimal growth.

### 7) Example 7: Preparation of a Powder of Nano-Chelated Complexes Including Nitrogen as Chelate Complex Core, Iron 12 wt % (Bioavailable Wt %) with Zinc and Manganese Fortification

### Importance of Milling Steps

In the production of a powder of nano-particles of chelated complex compounds including Nitrogen as chelate complex core, Iron 12 wt % (bioavailable wt %), the first step consists of a milling step of each raw material separately until they are between 100 nm and 300 nm using standard industrial milling technologies: all first and second source materials of cations and polycarboxylic acids, materials are described hereunder.

Once all materials are milled, the chelate complex core compounds formation through an addition of urea with a blend of polycarboxylic acids is made. Gradually, water is added, where the entire mixture is granulated using standard industrial high shear equipment. This step is considered as the chelate complex core formation [Blend 1]. Blend 1 is then passed through a wet milling step, prior to starting the secondary cation addition.

Further, Zinc Oxide with citric acid are added to the previous blend [Blend 1], followed by a granulation step, until mixture is uniform [Blend 2]. To Blend 2, Zinc Nitrate with itaconic acid are added. The entire mix is additionally granulated, with the gradual addition of water is added until the granulation is uniform [Blend 3].

To Blend 3, there is the addition of Zinc Sulfide with tartaric acid, then the whole is mixed, leading to the creation of the chelate complex core blend [Blend 1], with a secondary zinc free ion entrapped within the polycoarboxylic acid complex. The entire chelate complex blend [Blend 3] is wet milled to provide particles size of below 150 nm.

The weight ratio wt/wt of polycarboxylic acid(s) can be considered to be from 2:1 in the core and 1:3 following the addition of the zinc source elements.

To Blend 3, further microelements are added (based on the second source elements): iron oxide, iron sulfide and iron nitrate with water, and then succinic acid and citric acid and oxalic acid, where the whole is granulated leading to nano-chelated complexes including nitrogen as chelate core complex, enriched with iron 12 wt % (bioavailable wt %) [Blend 4]. At this stage, Blend 4 is wet milled until particle sizes are below 150 nm.

Further, to Blend 4, the following compounds are added successively:
Manganese oxide, Manganese sulfide and Manganese nitrate with water and butanetetracarboxylic acid and tartaric acid, [Blend 5]
   with blending at each sub-step and wet milling to provide particles size of below 100 nm having 3 cationic compounds.

The weight ratio between the chelate complex core compounds: second source materials is kept at 1:3 to 1:4.

Following the addition of the secondary sources of cations and staged milling, the final product is dried using a modified industrial flash dryer and pass it through a final milling stage.

All steps are performed with controlled temperatures of below 35° C. in contact with the product. These steps are repeated, as mentioned, in a gradual stages until drying is complete and the target particle size is achieved.

At each stage, powder flow, moisture (RH), and temperature (25° C.-35° C.) are tested.

In the case of the example mentioned, the obtained nano-chelated complex presents:
A Brownish red crystalline powder;
Appearance in liquid: Clear dark red liquid;
Density: 1.2 g/cm³ (measured using a pycnometer);
Freely soluble (OECD-105);
pH: <2 (OECD-122), Ion/pH meter.

It should be emphasized that the pH, powder flow properties, solubility and the cationic compounds concentration in polycarboxylic acids are key characteristics to determine the nano-chelated complexes stability and efficiency in optimizing plant growth and crop quality.

FIG. 5 depicts views of nano-chelated complexes obtained through milling steps according to the invention, by Scanning Electronic Microscope

TABLE 9
Product characteristics

| Macro-and micro- | Measured | Expected Product |
|---|---|---|
| elements | bioavailability % | Range % |
| N | 4 | [3.0-5.0] |
| Fe | 12 | [11.0-14.0] |
| Zn | 2 | [1.5-3.0] |
| Mn | 1.5 | [1.0-2.0] |
| OC | 10 | [9.0-12.0] |
| OM | 20 | [18.0-22.0] |
| Na | 1.3 | [0.5-2.0] |

Heavy metals Cd, Co, Hg, are lower than 2 ppm, Ni are lower than 30 ppm and Pb are lower than 5 ppm.

The bioavailable (free-ion) wt % are determined according to ASTM, OECD or ISO standard analytical methods and/or using a validated laboratory spectroscopy device (i.e. Perkin-Elmer ELAN 6000 ICP-OES). Some of specific laboratory methods used to assess product quality are; ISO/IEC 17025, ASTM D1217, OECD-105, OECD-122, OECD-109, ISO 22036-2008, OECD-120, ISO 11885/ESB.

It has been demonstrated over and over that when performing the process using initial predetermined quantities of polycarboxylic acids, first and second source materials as mentioned in this manufacturing summary, a stable and reproduceable product is obtained, with the expected product quality values as those obtained by GLP Laboratory.

To demonstrate the necessity of the staged milling, the exact process of the invention was performed, using the initially milled raw materials, while omitting the wet milling steps from the process steps. The milling was carried out solely at the end of the Blend 5 and following the drying step.

FIG. 4 depicts views of nano-particles of chelated complexes obtained through milling steps performed at the end of granulation and drying processes only. The views from the Scanning Electronic Microscope show that the milling steps at each successive addition of first and second materials and polycarboxylic acids, is of importance in order to obtain the desired end compounds, especially of spherical and ovaloid nanoparticles, or even tubular.

The experiment shows that by not performing the staged milling steps and only in the final stage of granulation and following drying, the process generates particles with final particles of chelated complex compounds that can no longer be considered as nano-particles, are much larger in size, for example 700 nm-3000 nm, and have a square and rectangular shape (FIG. 4), hence minimizing the surface area and potential absorption by the crops.

The desired nano-particles of chelated complex compounds according to the process of the invention would be spherical and ovaloid (or tubular) structure, as well as being in the desired nano-particle range (≤100 nm), as they have larger surface area and a particle size that are easier absorbed by the plants and crops (FIG. 5).

1.-20. (canceled)

21. Nano-particles of chelated complex compounds, useful as chelate fertilizers, comprising:
a chelate complex core made of at least one polycarboxylic acid and incorporating therein:
at least one first cationic compound originating from at least one first cationic source material of nitrogen (N), phosphorus (P), potassium (K), magnesium (Mg), calcium (Ca) or zinc (Zn), or mixtures thereof, and
at least one second cationic compound originating from at least one second cationic source material of nitrogen (N), phosphorus (P), potassium (K), magnesium (Mg), calcium (Ca), silicon (Si), iron (Fe), zinc (Zn), manganese (Mn), copper (Cu), boron (B), molybdenum (Mo), selenium (Se), cobalt (Co), sodium (Na), nickel (Ni), iodine (I), strontium (Sr), chromium (Cr) and organic carbon (OC), or mixtures thereof,
wherein the nano-particles of chelated complex compounds have a particle size that is ≤100 nm.

22. The nano-particles of chelated complex compounds according to claim 21, wherein the polycarboxylic acid is at least one acid selected from the group consisting of succinic acid (C₄H₆O₄), oxalic acid (C₂H₂O₄), malic acid (C₄H₆O₅), tartaric acid (C₄H₆O₆), citric acid (C₆H₈O₇), lactic acid (C₃H₆O₃), butanetetracarboxylic acid (C₈H₁₀O₈) and itaconic acid (C₅H₆O₄) or mixtures thereof.

23. The nano-particles of chelated complex compounds according to claim 21, wherein the chelate complex core consists only of said at least one polycarboxylic acid.

24. The nano-particles of chelated complex compounds according to claim 21, wherein the relative weight percent of the polycarboxylic acid in each nano-particle is selected in the list of range:
15 to 40 wt %, or
20 wt % to 35 wt %.

25. The nano-particles of chelated complex compounds according to claim 21, wherein the particle size of the chelated complex compounds is selected from the list of ranges:
10 nm to 100 nm,
15 nm to 90 nm,
20 to 80 nm, or
30 to 80 nm.

26. The nano-particles of chelated complex compounds according to claim 21, wherein the weight percentage of the first cationic compound in the core chelate complex is selected from the list of ranges:
5 to 35 wt %, 5 to 30 wt %, or
5 wt % to 25 wt %, and
wherein the rest weight % is the polycarboxylic acid, wherein wt % is the weight of the first cationic compound based of the total weight of the chelate complex core.

27. The nano-particles of chelated complex compounds according to claim 21, wherein the net weight percentage of each of the second cationic compounds in its soluble form, respectively the bioavailable percentage, based of the total mass of each particle is selected from the list of ranges:
0 to 20% of N,
0 to 30 wt % of K,
0 to 25 wt % of P,
0 to 25 wt % of Mg, Ca and Mn,
0 to 22 wt % of Zn,
0 to 15 wt % of Fe, or
0 to 15 wt % of Cu, Se, Co, Na, Ni, I, Sr, Cr, B, Si and OC, independently,
wherein the total weight % is different from 0, and the bioavailability percentage is measured by methods selected from the group consisting of ISO/IEC 17025, ASTM D1217, OECD-105, OECD-122, OECD-109, ISO 22036-2008, OECD-120 and ISO 11885/ESB.

28. A process for preparing nano-particles of chelated complex compounds, comprising the followings steps of:
a) adding a predetermined quantity of at least one polycarboxylic acid into a predetermined quantity of at least one first cationic source material providing at least one first cationic compound of nitrogen (N), phosphorus (P), potassium (K), magnesium (Mg), calcium (Ca), and zinc (Zn), or mixtures thereof, and blending the whole, thereby forming chelate complex core compounds made of the at least one polycarboxylic acid incorporating the at least one first cationic compound therein;
b) milling and particle sizing of the chelate complex core compounds obtained in step a);
c) adding a predetermined quantity of at least one second cationic source material providing at least one second cationic compound, of nitrogen (N), phosphorus (P), potassium (K), magnesium (Mg), calcium (Ca), silicon (Si), iron (Fe), zinc (Zn), manganese (Mn), copper (Cu), boron (B), molybdenum (Mo), selenium (Se), cobalt (Co), sodium (Na), nickel (Ni), iodine (I), strontium (Sr), chromium (Cr) and organic carbon (OC) or mixtures thereof, to the chelate complex core compounds, and of mixing thereof, resulting in a nano-chelated complexes mixture;
d) milling and particle sizing of the mixture obtained in step c) thereby forming nano-particles of chelated complex compounds, wherein a particle size thereof is ≤ 100 nm.

29. The process according to claim 28, wherein, before step a), the process includes an initial step of milling each of the raw materials, being the at least one polycarboxylic acid, first source material(s) and second source material(s), to obtain particles presenting sizes of about 100-300 nm.

30. The process according to claim 28, wherein the first source material for the first cationic compounds is urea, ammonium nitrate, zinc oxide, zinc sulphide, zinc nitrate, phosphoric anhydride (P₂O₅), triple superphosphate (TSP), di-ammonium phosphate, mono-ammonium phosphate (MAP), potassium oxide, potassium sulphide, potassium nitrate, magnesium oxide, magnesium sulphide, magnesium nitrate, calcium oxide, calcium sulphide and calcium nitrate, or mixture thereof.

31. The process according to claim 28, wherein the weight ratio polycarboxylic acid(s): first source material(s) is of from 2:1 to 1:3.

32. The process according to claim 28, wherein step a) is repeated multiple times.

33. The process according to claim 28, wherein step c) further includes the presence of said polycarboxylic acids added concomitantly with the second source materials, the weight ratio polycarboxylic acid(s): second source material(s) being of from 2:1 to 1:5.

34. The process according to claim 28, wherein the weight ratio between the chelate complex core(s): second source material(s) is of from 2:1 to 1:3.

35. The process according to claim 28, wherein the process includes, after step c) and before step d), an addition of water and a mixing step.

36. The process according to claim 28, wherein, after step d), the process includes a further step e) of drying and final particle sizing of the nano-chelated complexes.

37. The process according to claim 28, wherein the nano-chelated complexes undergo further purification step(s), step f), through filtration, sieving, crystallization and centrifugation.

38. The process according to claim 37, wherein, after step f), a further step consisting of final particle sizing of the nano-chelated complexes through additional wet milling is carried out.

39. The process according to claim 28, wherein the process is carried out at temperatures not higher than 35° C.

40. The process according to claim 28, wherein the process is carried out without the use of any further compounds selected from the group consisting of EDTA, EDDHHA, HEDTA, EDDHA, OTPA, multi-walled carbon nanotubes (MWCNTs), hydroxyfullerenes, iron dioxide (FeO₂), silver nanoparticles (AgNPs), silicon dioxide (SiO₂), titanium dioxide (TiO₂), silver oxides, catalysts, dispersants, nano-additives and preservatives, or mixtures thereof.
